(19) United States
(12) Patent Application Publication
(10) Pub. No.: US 2026/0195737 A1
(43) Pub. Date: Jul. 9, 2026

(54) DIGITAL-WALLET-INTEGRATED MOBILE AUTHENTICATION

(71) Applicant: Wells Fargo Bank, N.A., San Francisco, CA (US)

(72) Inventors: Mary P. Casey, Edina, MN (US); Kami J. Hanson, Columbus, MN (US); Ryan Michael Hegland, Lakeville, MN (US)

(21) Appl. No.: 19/009,742

(22) Filed: Jan. 3, 2025

(51) Int. Cl. G06Q 20/36; G06Q 20/40

(52) U.S. Cl. CPC G06Q 20/3674; G06Q 20/4014; G06Q 20/4016

(57) ABSTRACT

A method may include receiving a request to perform an action with a mobile application, the request including a user identifier and a set of authentication parameters; determining that the set of authentication parameters are insufficient to authenticate the user identifier for the action; based on the determining, requesting an additional authentication parameter; subsequent to the requesting, receiving an encoded identification identifier from a digital wallet application; verifying the encoded identification identifier from the digital wallet application matches an encoded identification identifier associated with the user identifier; and based on the verifying, authorizing the requested action to be performed on the mobile application.

### BACKGROUND

Traditional mobile application security face different challenges depending on implementation. Passwords and other traditional methods require users to memorize each password used, which may be complicated by complex password requirements and safe password practices. Mobile devices present challenges for authentication, such as use in public spaces and constrained input options.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Like numerals having different letter suffixes may represent different instances of similar components. Some embodiments are illustrated by way of example, and not limitation, in the figures of the accompanying drawing.

FIG. 1 is an illustration of components of a client device and an application server, as well as a digital identity server according to various examples.

FIG. 2 is a diagram illustrating a user interface for authentication and identity request, according to some examples.

FIG. 3 is a flowchart illustrating a method for authenticating and authorizing actions in a mobile application, according to some examples.

FIG. 4 is a block diagram illustrating a machine in the example form of a computer system, within which a set or sequence of instructions may be executed to cause the machine to perform any one of the methodologies discussed herein, according to various examples.

### DETAILED DESCRIPTION

Traditional mobile application security faces several challenges stemming from the unique characteristics of mobile devices and the need to balance security with user convenience. Passwords and other traditional authentication methods may require users to memorize complex combinations of characters for each application. This may be particularly challenging on mobile devices as mobile devices may have limited input options and the tendency for users to choose simpler, less secure passwords for convenience.

Furthermore, mobile devices are frequently used in public spaces, which may increase the risk of unauthorized access through shoulder surfing or device theft. As such, additional security measures beyond simple password protection may be desired. The small screens and touch-based interfaces of mobile devices may make entering complex passwords or other authentication credentials difficult and error-prone. This may lead to user frustration and may compromise security if users opt for less secure authentication methods.

Another problem with mobile application security is that users may have numerous applications on their mobile devices, each potentially requiring separate authentication. This proliferation of login credentials may lead to password reuse across applications, significantly increasing security risks if one account is compromised. Finding the right balance between robust security measures and user-friendly interfaces is a challenge. Overly complex security protocols may discourage users from using the application or lead them to circumvent security measures, while others may not provide adequate protection.

An additional problem is that the mobile application landscape is diverse, with various platforms and development frameworks. This diversity may lead to inconsistent security implementations across different applications and may create vulnerabilities or confusion for users. Additionally, mobile applications face an evolving array of security threats, from malware to sophisticated phishing attacks. Keeping up with these threats while maintaining a seamless user experience presents an ongoing challenge for developers and security professionals.

Given the above problems, systems and methods are described herein to address these challenges by introducing a multi-factor authentication system that leverages digital wallet applications and mobile driver's licenses. These systems and methods enhance security while maintaining user convenience.

When a user attempts to perform an action within a mobile application, an authentication process is initiated. A mobile application may receive a request to perform an action, and the request may include a user identifier and a set of initial authentication parameters. The system may then evaluate the provided authentication parameters. In some examples, these parameters may include a numerical code (e.g., a personal identification number (PIN)) but exclude a password. The authentication component may then determine whether the provided parameters are sufficient to authenticate the user for the requested action.

If the initial authentication parameters are deemed insufficient, the system may request an additional authentication parameter. This request may be transmitted to the digital wallet application installed on the client device. In some examples, this transmission may occur through a deep link encoded with an identifier of the mobile application and user identifier.

The digital wallet application may then provide an encoded identification identifier. This identifier may come from a mobile driver's license stored within the digital wallet application. In some examples, this encoded identification identifier may be digitally signed to ensure its authenticity and integrity. Upon receiving the encoded identification identifier from the digital wallet application, the system may verify it against an encoded identification identifier associated with the user in the system's records. This verification process may involve communicating with the authority that issued the mobile driver's license to confirm the authenticity of the identifier.

If the verification is successful, the system may authorize the requested action to be performed on the mobile application. This multi-step process ensures a higher level of security while leveraging the convenience of digital wallet applications and mobile driver's licenses.

The described examples also may incorporate a risk assessment component. The system may classify each requested action to a risk level. This classification allows for adaptive authentication, where the level of authentication required may correspond to the risk associated with the action. The system may compare the risk level of the requested action to the current level of authentication of the user.

In some examples, the system may handle multiple actions with different risk levels within the same session. For instance, if a user requests a second action with a higher risk level than the first, the system may compare this new risk level to the current level of authentication. If the current authentication level is insufficient for the higher-risk action, the system may request another additional authentication parameter. This additional parameter may be a password, demonstrating how the system may escalate the authentication requirements based on the risk level of the requested actions.

The following description outlines specific examples to provide a thorough understanding of various inventive aspects. It will be evident, however, to one skilled in the art that the present invention may be practiced without these specific details. References in the specification to “one example,” “an example,” “an illustrative example,” etc., indicate that the example described may include a particular feature, structure, etc. Still, every example may not necessarily include that particular feature. Additionally, such phrases do not imply a single example, and the features may be incorporated into other examples described. It may be appreciated that lists in the form of “at least one A, B, and C” may mean (A); (B); (C): (A and B); (B and C); or (A, B, and C). Similarly, items listed in the form of “at least one of A, B, or C” may mean (A); (B); (C): (A and B); (B and C); or (A, B, and C). Furthermore, using such phrases does not negate the possibility of other options (e.g., (D)).

Throughout this disclosure, components may perform electronic actions in response to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. End-users or administrators may use user interfaces to edit the variable values.

In various examples described herein, user interfaces are described as being presented to a computing device. The presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples, these portions may be displayed on a screen simultaneously, in others, the portions/elements may be displayed on separate screens such that not all portions/elements are displayed simultaneously. Unless explicitly indicated as such, the use of “presenting a user interface” does not infer either one of these options.

Additionally, the elements and portions are sometimes described as being configured for a particular purpose. For example, an input element may be configured to receive an input string, a selection from a menu, a checkbox, etc. In this context, “configured to” may mean presenting a user interface element capable of receiving user input. “Configured to” may additionally mean computer executable code processes interactions with the element/portion based on an event handler. Thus, a “search” button element may be configured to pass text received in the input element to a search routine that formats and executes a structured query language (SQL) query to a database.

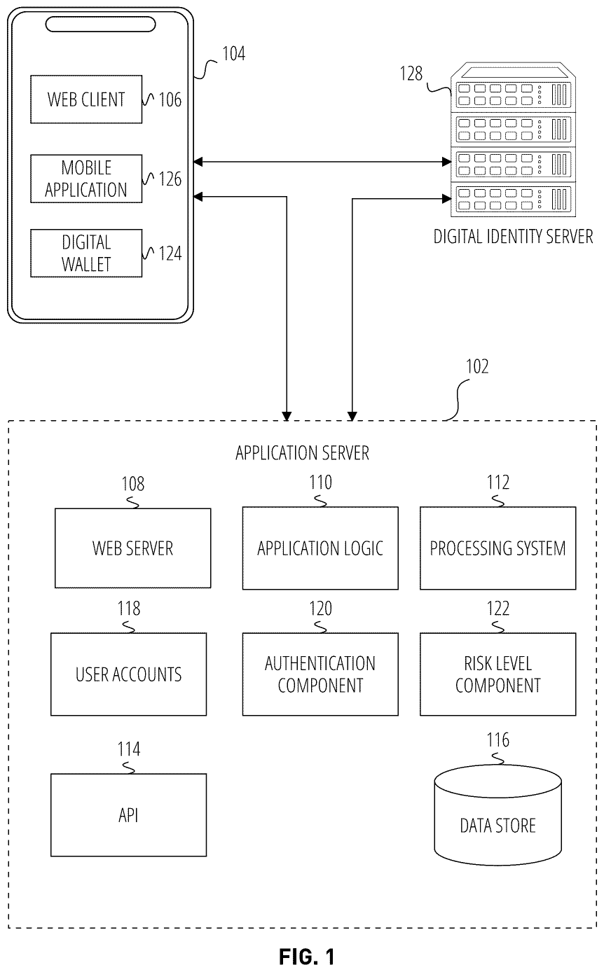

FIG. 1 illustrates the components of a client device and an application server according to various examples. FIG. 1 includes an application server 102, a client device 104, a web client 106, a web server 108, an application logic 110, a processing system 112, an API 114, a data store 116, a user accounts 118, an authentication component 120, a risk level component 122, a digital wallet 124, a mobile application 126, and a digital identity server 128.

Application server 102 is illustrated as separate elements (e.g., components). However, the functionality of multiple individual elements may be performed by a single element. An element may represent computer program code executable by processing system 112. The program code may be stored on a storage device (e.g., data store 116) and loaded into the memory of the processing system 112 for execution. Portions of the program code may be executed in parallel across multiple processing units. A processing unit may be a grouping of one or more cores of a general-purpose computer processor, a graphical processing unit, an application-specific integrated circuit, or a tensor processing core. Furthermore, the grouping may operate on a single device or multiple devices (either collocated or geographically dispersed). Accordingly, code execution using a processing unit may be performed on a single device or distributed across multiple devices. In some examples, using shared computing infrastructure, the program code may be executed on a cloud platform (e.g., MICROSOFT AZURE® and AMAZON EC2®). Additionally, in some examples, the described functionality attributable to the elements in application server 102 may be performed by client device 104.

Client device 104 may be a computing device which may be but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., specially configured user interfaces). In some embodiments, computing devices may comprise one or more of a touch screen, camera, keyboard, microphone, or Global Positioning System (GPS) device.

Client device 104 and application server 102 may communicate via a network (not shown). The network may include local-area networks (LAN), wide-area networks (WAN), wireless networks (e.g., 802.11 or cellular network), Public Switched Telephone Network (PSTN), ad hoc networks, cellular, personal area networks or peer-to-peer (e.g., Bluetooth®, Wi-Fi Direct), or other combinations or permutations of network protocols and network types. The network may include a single Local Area Network (LAN), Wide-Area Network (WAN), or combinations of LANs or WANs, such as the Internet.

In some examples, the communication may occur using an application programming interface (API) such as API 114. An API provides a method for computing processes to exchange data. A web-based API (e.g., API 114) may permit communications between two or more computing devices, such as a client and a server. The API may define a set of HTTP calls according to Representational State Transfer (RESTful) practices. For example, A RESTful API may define various GET, PUT, POST, and DELETE methods to create, replace, update, and delete data stored in a database (e.g., data store 116)

APIs may also be defined in frameworks provided by an operating system (OS) to access data in an application that an application may not regularly be permitted to access. For example, the OS may define an API call to obtain the current location of a mobile device the OS is installed on. In another example, an application provider may use an API call to request user authentication using a digital wallet application on the mobile device. The API call may initiate a process where the digital wallet application is prompted to provide an encoded identification identifier, such as one derived from a mobile driver's license stored within the digital wallet. The API may facilitate the secure transmission of this encoded identification identifier from the digital wallet application to the authentication component to handle sensitive information. In another example, an application provider may use an API call to authenticate a user using a biometric sensor on the mobile device. By segregating any underlying biometric data—e.g., by using a secure element—the risk of unauthorized transmission of the biometric data may be lowered.

Application server 102 may include web server 108 to enable data exchanges with client device 104 via web client 106. Although generally discussed in the context of delivering webpages via the Hypertext Transfer Protocol (HTTP), other network protocols may be utilized by web server 108 (e.g., File Transfer Protocol, Telnet, Secure Shell, etc.). A user may enter a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 108. In response, web server 108 may transmit a web page rendered on a client device's display device (e.g., a mobile phone, desktop computer, etc.).

Additionally, web server 108 may enable users to interact with one or more web applications provided in a transmitted web page. A web application may provide user interface (UI) components rendered on a display device of the client device 104. The user may interact (e.g., select, move, enter text into) with the UI components, and, based on the interaction, the web application may update one or more portions of the web page. A web application may be executed in whole or in part locally on client device 104. The web application may populate the UI components with data from external or internal sources (e.g., data store 116) in various examples.

In various examples, the web application may be a dynamic user interface and may include an environment illustrating an authentication process, an identity request process, or a combination of both processes. The web application may provide input elements for users to enter authentication parameters, such as a numerical code or other credentials. The web application may also display prompts for additional authentication when required, such as requests for encoded identification identifiers from a digital wallet application.

The web application may include functionality to interact with at least one of the authentication component 120 and the risk level component 122 of the application server 102. This interaction may allow the web application to dynamically adjust the authentication requirements based on the risk level of requested actions. For example, it may present different authentication interfaces for low-risk versus high-risk actions.

Additionally, the web application may provide a user interface for managing digital wallet integration, allowing users to link their digital wallet applications and authorize the use of mobile driver's licenses for authentication purposes. This interface may include options for users to review and control which identification information is shared during the authentication process.

The web application may be executed according to application logic 110. Application logic 110 may use the various elements of application server 102 to implement the web application. For example, application logic 110 may issue API calls to retrieve or store data from data store 116 and transmit it for display on client device 104. Similarly, data entered by a user into a UI component may be transmitted using API 114 back to the web server. Application logic 110 may use other elements (e.g., authentication component 120, risk level component 122, etc.) of application server 102 to perform functionality associated with the web application as described further herein.

Data store 116 may store data that is used by application server 102. Data store 116 is depicted as a singular element but may be multiple data stores. The data store 116 may include several databases of varying model architectures such as, but not limited to, a relational database (e.g., SQL), a non-relational database (NoSQL), a flat-file database, an object model, a document details model, graph database, shared ledger (e.g., blockchain), or a file system hierarchy. Data store 116 may store data on one or more storage devices (e.g., a hard disk, random access memory (RAM), etc.). The storage devices may be in standalone arrays, part of one or more servers, and located in one or more geographic areas.

In some examples, data store 116 may include user accounts 118, which may store user profiles on users of application server 102. A user profile may include credential information, such as legal name, a user name, a password hash, or a personal identification number (PIN) hash. It may also contain authorization to access other services in which the user has an account, including tokens (e.g., using OAuth) or login credentials. User preferences and information about computing devices associated with the user, such as registered phones, desktop computers, tablets, or laptops, may also be stored.

Data store 116 may contain information related to the digital wallet integration and mobile driver's license verification processes. This may include encrypted storage for digital wallet credentials, such as tokenized representations of mobile driver's licenses. The data store may maintain a record of verified mobile driver's licenses, including their issuance authorities, expiration dates, and the last verification timestamp.

In some examples, data store 116 may include a mapping between user accounts and their associated digital wallet identifiers, allowing for integration between the mobile application 126 and the digital wallet 124. Data store 116 may store logs of digital wallet interactions, including requests for encoded identification identifiers and the outcomes of these requests.

In some examples, data store 116 may include data structures to support a risk-based authentication process. Such data structures may include risk profiles for different types of actions, user behavior patterns, or historical authentication data to inform the risk level component 122 in its decision-making process. Data store 116 may maintain session information, including current authentication levels or any step-up authentication requirements based on risk assessments.

Data structures may be implemented in several ways depending on the programming language of an application or the database management system used by an application. For example, if C++ is used, the data structure may implemented as a struct or class. In the context of a relational database, a data structure may be defined in a schema.

User accounts 118 may include user profiles on users of application server 102. A user profile may include credential information such as a username and hash of a password. A user may enter their username and plaintext password on a login page of application server 102 to view their user profile information or interfaces presented by application server 102 in various examples.

A user profile may also include authorization to access other services in which the user has an account. The authorizations may include a token (e.g., using OAuth) or login credentials that authorize application server 102 to retrieve data from the other services in a defined format, such as JavaScript Object Notation (JSON) or extensible markup language (XML) over an API. A reciprocal authorization may also be stored in the user profile that authorizes the other services to access data stored in the user profile. The user profile may also include information related to the mobile banking application and digital wallet integration. For example, the user profile may store the legal name associated with the account, the username for login purposes, or hashed versions of the password, PIN, or both, or any combination within for secure storage. In some examples, the user profile may store account-specific data, preferences, and risk thresholds for different types of actions such as a login, viewing account information, editing details, performing a transfer, or any combination within.

A user account may also include the user's preferences. The preferences may include a setting related to authentication methods, communication preferences, or risk thresholds for different types of actions. For example, user preferences may include settings for authentication methods, such as biometric, PIN, or password options. A user may also set preferences for communication methods, like email or text notifications.

A user account may include risk thresholds for different types of actions within the mobile banking application. The risk thresholds may be modified with advanced permissions, such as by an administrator, stored policy, or the like. For example, an administrator may set lower thresholds for viewing account information or higher thresholds for performing transfers, editing account details, or the like, depending on a user account.

A user account may also identify computing devices associated with the user. For example, users may register one or more phones, desktop computers, tablets, or laptops with application server 102. Registering may include authorizing application server 102 to retrieve data from these devices, such as location data, browser history, etc. Users may revoke access to any such data at any time by updating their profile. The data may be gathered via an application installed on a registered device, such as by downloading an application from an app store associated with their mobile phone platform.

After enrollment, a user profile may be generated and stored on data store 116. In various examples, the enrollment process does not need to be completed in an online environment. Thus, a user may physically go to a bank branch to enroll as a customer. To discuss the accounts of a user more easily (e.g., checking accounts, mortgage accounts) versus the user account, this disclosure uses the term “user profile” for the user account created after the enrollment process.

“Associated” in the context of linking an account to a user profile (or other data linkages described herein) may be implemented differently depending on the underlying database system. For example, in a relational database management system (RDBMS), “associated” may refer to the relationship between tables. The relationship could be one-to-one, one-to-many, or many-to-many, established through foreign key constraints. For example, in a one-to-many relationship, a record in Table A (e.g., the user profile table) may be associated with multiple records in Table B (e.g., a user account table), using a foreign key in Table B that references the primary key in Table A.

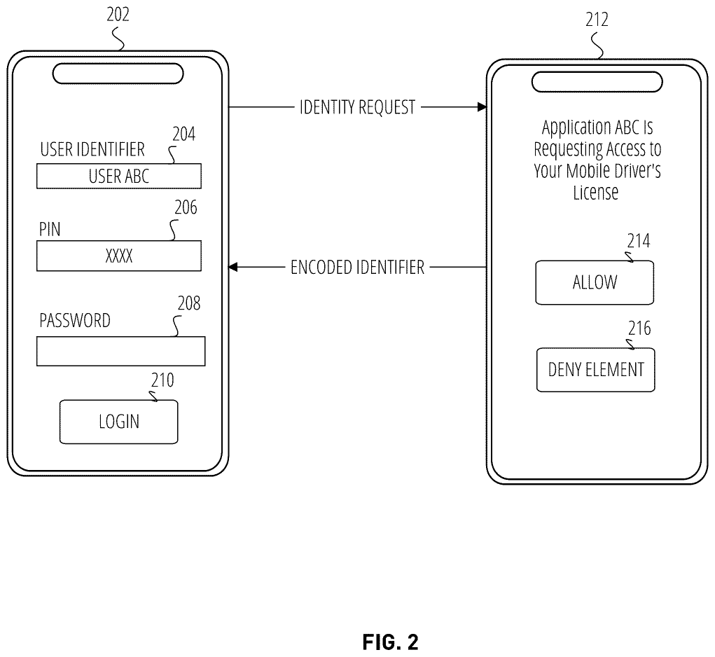

Authentication component 120 may include functionality for verifying user identities and managing authentication levels within the system. For example, authentication component 120 may receive a request to verify a user identity, which may include a user identifier, a password, other initial authentication parameters (e.g., a PIN, biometric data, a security question and answer, location data, a time-based token, or the like), or any combination thereof. In some examples, the initial authentication parameters may include a numerical code or other non-password authentication parameters, and exclude a password. Authentication component 120 may work in conjunction with a login action 210, as described in FIG. 2 below.

Authentication component 120 may work in conjunction with a risk level component 122 to implement a risk-based authentication system. A risk-based authentication system may compare a risk level of a requested action to a current authentication level of a user. If the current authentication level is insufficient for a higher-risk action, the component may request another additional authentication parameter, such as a password.

The authentication component 120 may interface with other components to leverage data sources or functionalities to provide context-aware authentication services. The authentication component 120 may access user profile information, stored credentials, authentication history, or any combination thereof from user accounts 118 to verify user identities and determine appropriate authentication levels. Authentication component 120 may retrieve and update authentication-related data, such as encoded identification identifiers associated with users, risk profiles, or session information from the data store 116.

In some examples, authentication component 120 may work in tandem with the risk level component 122 to implement risk-based authentication by adjusting authentication requirements based on the perceived risk of requested actions. Authentication component 120 may interact with the digital wallet 124 of the client device 104 to request and receive additional authentication parameters, such as encoded identification identifiers from mobile driver's licenses. The authentication component 120 may use the API 114 to communicate with external systems or services, such as government authorities that issue mobile driver's licenses, to verify the authenticity of provided credentials. Web server 108 and application logic 110 may be involved in processing authentication requests and responses to facilitate secure communication between the client device 104 and the authentication component 120.

Authentication component 120 may maintain records of current authentication levels for user sessions, which may allow tracking of the authentication status of users throughout interactions with the application. These records may include information such as the types of authentication methods used, the timestamp of the last successful authentication, and the current authentication level assigned to the session. In some examples, authentication component 120 may generate and maintain audit logs of authentication-related activities. These logs may capture information about authentication attempts, successful authentications, failed authentications, changes in authentication levels, requests for additional authentication parameters, or any combination thereof. The audit logs may include timestamps, user identifiers, action types, outcomes of authentication processes, or any combination thereof.

Risk level component 122 may assess, classify, or assess and classify the risk associated with different actions within the system. The risk level component 122 may classify each requested action to a risk level. This classification may allow for adaptive authentication, where the level of authentication required may correspond to a risk associated with the action. For example, viewing account information may be classified as a lower risk action compared to performing a funds transfer, which may be classified as a higher risk action. In some examples, when a user requests to perform an action, the risk level component 122 may evaluate various factors to determine the risk level. These factors could include the nature of the action, the user's historical behavior patterns, the current device information, the current location information, or the like. The factors may be stored as contextual data in the data store 116.

In some examples, the risk level component 122 may maintain a database of risk profiles for different types of actions within the system. The database may serve as a reference point for quickly assessing the risk level associated with various requested actions. Risk profiles stored in this database may contain information about the characteristics or potential security implications of different actions that may be performed within the mobile application.

A risk profile may include a factor related to the nature of the action (e.g., viewing account information, editing personal details, performing financial transactions), historical data on the frequency and patterns of similar actions, potential impact or sensitivity of the data involved, known vulnerabilities or attack vectors associated with specific action types, or any combination thereof. A risk profile database may also incorporate dynamic elements, allowing for periodic updates based on new threat intelligence or changes in regulatory requirements. The risk level component 122 may inform the authentication component 120 about the level of authentication required for each action.

Risk level component 122 may work in conjunction with authentication component 120 to implement a risk-based authentication system. Once the risk level is determined, the risk level component 122 may communicate this information to the authentication component 120. The authentication component may compare the risk level to the current level of authentication of the user. If the current authentication level is insufficient for the risk level of the requested action, additional authentication steps may be required. In some examples, if multiple actions with different risk levels are requested within the same session, the risk level component 122 may dynamically adjust the authentication requirements. For example, if a user requests a second action with a higher risk level than the first, the component may trigger a request for additional authentication parameters.

Digital wallet 124 may serve as a storage and access point for digital identification credentials, including mobile driver's licenses. Digital wallet 124 may reside on the client device 104 and interact with the mobile application 126 or the authentication component 120 on the application server 102.

Digital wallet 124 may store digital credentials, such as mobile driver licenses. When an additional authentication parameter is requested by the authentication component 120, the digital wallet 124 may be prompted to provide an encoded identification identifier. This identifier may be derived from the mobile driver's license (e.g., a nonce, one-time code, or encryption key) stored within the digital wallet. The encoded identification identifier may be digitally signed to ensure its authenticity and integrity. The digital signature may be verified by the authentication component 120 or by communicating with the authority that issued the mobile driver's license, such as through digital identity server 128.

In some examples, digital wallet 124 may interact with the mobile application 126 through a deep link, which may be encoded with an identifier of the mobile application 126 and the user identifier. The deep link may allow for integration between the two applications, such as by containing encoded information about the mobile application 126 requesting authentication and the user identifier associated with the request. When activated, the deep link may launch the digital wallet 124 and navigate directly to the relevant section for providing the additional authentication parameter.

Digital wallet 124 may present a user interface to the user. The user interface may request permission to share the encoded identification identifier with a requesting application. The user interface may display details, such as the name of the requesting application, the type of information being requested (i.e., an encoded identification identifier), the purpose for which this information is requested, or any combination thereof. The user may be presented with options to allow or deny the request.

The encoded identification identifier provided by the digital wallet 124 may be digitally signed. A digital signature may be generated using cryptographic techniques, which may utilize a private key associated with the digital wallet or the mobile driver's license issuer. When the authentication component 120 receives the encoded identification identifier, the authentication component 120 may verify the digital signature. The verification process may involve using a corresponding public key to check the signature's validity. In some examples, the authentication component 120 may communicate with the authority that issued the mobile driver's license, such as digital identity server 128, to confirm the authenticity of the identifier.

Mobile application 126 may be a component in the authentication and authorization process. In some examples, the mobile application 126 may be an application related to financial services, such as banking, credit monitoring, financial tracking, or the like. In some examples, the mobile application 126 may be any application that handles sensitive user data, such as healthcare services, real estate applications, travel booking services, e-commerce platforms, or the like.

When a user attempts to perform an action within the mobile application 126, an authentication process may be initiated. The mobile application 126 may receive a request to perform an action, and the request may include a user identifier or a set of initial authentication parameters. The authentication component 120 may evaluate a provided authentication parameter and determine whether the provided parameters are sufficient to authenticate the user for the requested action. In some examples, if the verification is successful, application server 102 may authorize the requested action to be performed on the mobile application 126.

Digital identity server 128 may be an external system for issuing and verifying mobile driver's licenses. If the authentication component 120 needs to verify the authenticity of an encoded identification identifier received from the digital wallet 124, the authentication component 120 may communicate with the digital identity server 128.

During the verification process, authentication component 120 may send a request to digital identity server 128 to confirm the authenticity of the encoded identification identifier. In some examples, the digital identity server 128 may check if the mobile driver's license is still valid and has not been revoked, suspended, expired, fake, or the like. The verification process may involve checking the validity and status of the mobile driver's license associated with the encoded identification identifier received from the digital wallet 124. The digital identity server 128 may validate the credentials provided through the digital wallet.

Verifying with digital identity server 128 may provide an additional layer of security into the authentication process. This verification step may verify that the credentials provided through the digital wallet are correctly formatted, digitally signed, and currently valid according to the issuing authority.

FIG. 2 is a diagram illustrating a user interface for authentication and identity request, according to some examples. FIG. 2 includes a login interface 202, user identifier input 204, a PIN input 206, a password input 208, a login action 210, an authentication interface 212, an allow element 214, and a deny element 216.

The login interface 202 may be a component of a user interface for authentication or sign-in purposes. The login interface 202 may be present on a user device, such as the client device 104 as discussed in FIG. 1. The login interface 202 may serve as an initial point of interaction for users attempting to access a mobile application on the user device, such as mobile application 126. The login interface 202 may include several elements designed to facilitate user authentication, such as user identifier input 204, PIN input 206, password input 208, login action 210, or any combination thereof. These selectable indications are shown on a single user interface for convenience but may be displayed on separate user interfaces, may be displayed individually, as part of user interfaces with other information or selectable indications, or may not each be displayed. In some examples, the login interface 202 may include a selectable element to display the authentication interface 212.

In some examples, the login interface 202 may be designed with accessibility features in mind. These features may include support for screen readers, keyboard navigation, and appropriate color contrast to ensure usability for users with various abilities. In some examples, the login interface 202 may also incorporate security measures to protect against automated attacks. These measures may include rate limiting on submission attempts, integration with CAPTCHA systems for monitoring suspicious activity, or the like.

In some examples, the login interface 202 may display a user identifier input 204. The user identifier input 204 may allow users to enter a unique identifier associated with their account. The user identifier input 204 may accept various types of identifiers, such as usernames, email addresses, account numbers, or the like, depending on a system's configuration. In some examples, the user identifier input 204 may incorporate auto-completion functionality. As a user begins typing, the system may suggest matching identifiers from a database of registered users. In some examples, the user identifier input 204 may include input validation mechanisms. These mechanisms may check the entered identifier against predefined patterns or formats to ensure it meets the system's requirements. For instance, if the identifier is expected to be an email address, the input field may verify that the entered text contains the “@” symbol and a valid domain.

The user identifier input 204 may interact with other components of the authentication system. Upon entry of a valid identifier, the system may retrieve associated account information to determine which authentication methods are available or required for that specific user. This interaction may affect the display of subsequent authentication fields, such as PIN input 206, password input 208, or a selectable element to display authentication interface 212.

The login interface 202 may include a PIN input 206. The PIN input 206 may be designed for users to enter a numerical code as part of the initial authentication process. The PIN input 206 may include input validation mechanisms. These mechanisms may check an entered PIN against predefined criteria to ensure it meets the system's requirements. For instance, the input field may verify that the entered code consists of the correct number of digits and contains only numerical characters. In some examples, the PIN may serve as one of the authentication parameters that excludes a password. In some examples, the PIN input 206 may interact with other components of the authentication system. Upon entry of a valid PIN, the system may compare it with the stored PIN hash associated with the user identifier. This interaction may affect the authentication process, potentially determining whether additional authentication steps are required such as requiring additional information or access to a mobile driver's license through an authentication interface 212.

The login interface 202 may include a password input 208. The password input 208 may allow users to enter their password as an additional authentication parameter when required. The password input 208 may be designed to accept alphanumeric characters and special symbols, depending on the system's password complexity requirements. In some examples, the password input 208 may incorporate input masking functionality. As the user enters their password, the system may display asterisks or dots instead of the actual characters to protect the password from visual observation. The password input 208 may include input validation mechanisms. These mechanisms may check the entered password against predefined criteria to ensure it meets the system's requirements. For instance, the input may verify that the entered password meets minimum length requirements or contains a mix of characters, such as uppercase or lowercase letters, numbers, special characters, or any combinations thereof.

In some examples, the password input 208 may interact with other components of the authentication system. Upon entry of a valid password, the system may compare it with the stored password hash associated with the user identifier. This interaction may affect the authentication process, potentially determining whether additional authentication steps are required, such as requiring additional information or access to a mobile driver's license through an authentication interface 212.

The login interface 202 may feature login action 210. Login action 210, when activated, may initiate the authentication process using the provided credentials. Upon activation, login action 210 may trigger the system to evaluate the entered authentication parameters and determine if the entered authentication parameters are sufficient for a requested action. The login action 210 may interface with other components of the authentication system, such as authentication component 120. When activated, the login action 210 may communicate with the authentication component 120 to initiate the evaluation of the provided credentials. This communication may occur through the API 114, which may facilitate data exchange between the client device 104 and the application server 102.

In some examples, the login action 210 may trigger a series of operations within the authentication component 120. These operations may include comparing the entered credentials with stored hashes in the user accounts 118, assessing the risk level of the requested action using the risk level component 122, determining if additional authentication steps are necessary, or any combination thereof. For example, upon receiving the authentication request, the authentication component 120 may first verify the provided user identifier against the user accounts 118 stored in data store 116. This verification process may involve comparing the entered credentials, such as a username and password hash or PIN hash, with the stored information associated with the user identifier.

In some examples, after verifying the basic credentials, the authentication component 120 may work in conjunction with the risk level component 122 to implement a risk-based authentication system. This process may involve classifying the requested action to a risk level and comparing it to the current level of authentication of the user. For example, if the user is attempting to view account information, this may be classified as a lower-risk action compared to performing a funds transfer, which may be classified as a higher-risk action.

In some examples, if the initial authentication parameters are deemed insufficient for the risk level of the requested action, the authentication component 120 may request an additional authentication parameter. This request may be transmitted to the digital wallet application installed on the client device 104, such as through a deep link encoded with an identifier of the mobile application, user identifier, or combination thereof. Upon receiving an encoded identification identifier from the digital wallet application, the authentication component 120 may verify it against an encoded identification identifier associated with a user. In some examples, the verification process may involve communicating with the authority that issued the mobile driver's license to confirm the authenticity of the identifier. If the verification is successful and the authentication level is deemed sufficient for the requested action, the authentication component 120 may authorize the login action 210 to proceed with a log in request.

If the verification is successful and the authentication level is deemed sufficient for the requested action, the authentication component 120 may authorize the requested action to be performed on the mobile application.

The login action 210 may also interact with the digital wallet 124 if additional authentication is required. In such cases, it may initiate a request for an encoded identification identifier from the digital wallet application. In some examples, login action 210 may be selected without including any credentials. In these examples, upon activation, the login action 210 may interact with the digital wallet 124 to automatically initiate a request for an encoded identification identifier from the digital wallet application.

The system's response to the activation of the login action 210 may vary based on the outcome of the authentication process. In some examples, if the provided credentials are sufficient, the login action 210 may authorize the requested action to be performed on the mobile application 126. If the authentication parameters are deemed insufficient for the risk level of the requested action or additional authentication is required, the login action 210 may trigger the display of the authentication interface 212, prompting the user for additional authentication parameters.

The login interface 202 may be designed to allow users to bypass the initial authentication parameters and directly access the authentication interface 212 through an identity request. This functionality may provide users with an alternative authentication method that leverages the digital wallet application and mobile driver's license. The authentication interface 212 may be automatically provided to a user upon opening the login interface 202, or the login interface 202 may include a selectable element to display the authentication interface 212. In some examples, the authentication interface 212 may be provided in response to a failed verification of credentials. In some examples, the authentication interface 212 may be provided in response to a requested action classified in a certain risk level. The authentication interface 212 may bypass the need for entering initial authentication parameters such as a username or password.

The login interface 202 may interface with authentication interface 212 through an identity request, where the login interface 202 sends a request to the authentication component 120 to initiate the additional authentication process. The authentication component 120 may then trigger the display of the authentication interface 212, prompting the user to provide an encoded identification identifier from their digital wallet application, such as through allow element 214.

Authentication interface 212 may display details about the authentication request and provide the user with options to allow or deny the request through the allow element 214 and deny element 216.

If the user chooses to allow the request through allow element 214, the interface may trigger the digital wallet 124 to provide the required encoded identification identifier, which may then be verified by the authentication component 120. By selecting the allow element 214, the user may consent to share their encoded identification identifier for authentication purposes. This alternative authentication flow may be useful for users who frequently access the system and prefer a more familiar authentication method, while still maintaining the high level of security of digitally signed mobile driver's licenses.

If the user chooses to deny the request through deny element 216, deny element 216 may signal to the authentication component 120 that the user has declined to provide the additional authentication parameter. By selecting deny element 216, the authentication process may be terminated or a user may return to a previous authentication step, depending on the system's configuration. In some examples, a user may be prompted to input authentication parameters following selecting the deny element 216. In other examples, a user may be informed that access to a mobile driver's license is required for a requested action.

The allow element 214 and the deny element 216 are shown on a single user interface for convenience but may be displayed on separate user interfaces, may be displayed individually, as part of user interfaces with other information or selectable indications, or may not each be displayed. In some examples, instead of presenting the allow element 214 and deny element 216, the authentication interface 212 may prompt the user to add a mobile driver's license to their digital wallet 124 if one is not already present. This prompt may be triggered when the system detects that the user does not have a valid mobile driver's license stored in their digital wallet application. The interface may provide instructions on how to obtain and add a mobile driver's license to the digital wallet 124, potentially including links to relevant issuing authorities or step-by-step guidance. Once the mobile driver's license is added to the digital wallet 124, the user may then be presented with the option to use it for authentication, similar to the functionality of the allow element 214.

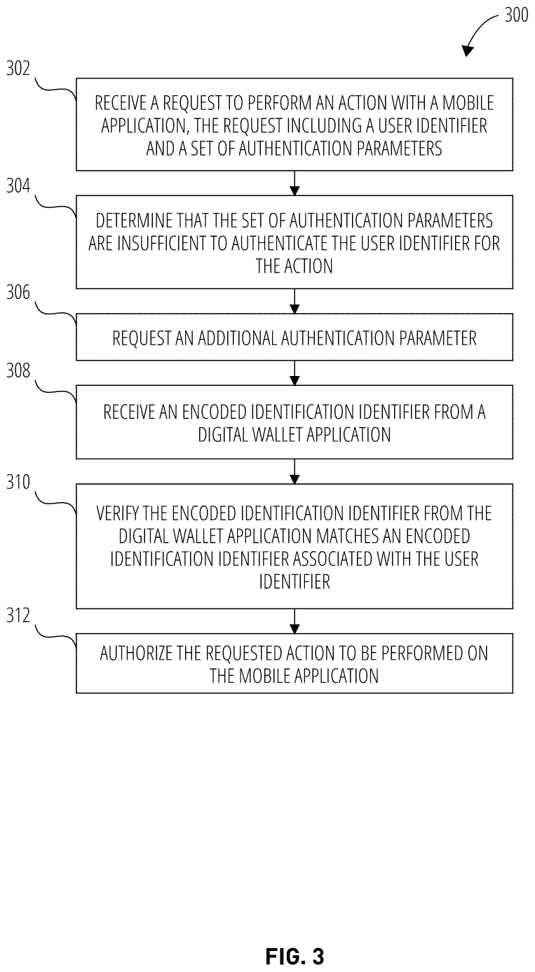

FIG. 3 is a flowchart illustrating a method 300 for authenticating and authorizing actions in a mobile application, according to some examples. The method 300 is represented as a set of blocks that describe blocks 302 to block 312. The method may be embodied in a set of instructions stored in at least one computer-readable storage device of a computing device. A computer-readable storage device excludes transitory signals. In contrast, a signal-bearing medium may include such transitory signals. A machine-readable medium may be a computer-readable storage device or a signal-bearing medium. Although the example method 300 depicts a particular sequence of operations, the sequence may be altered without departing from the scope of the present disclosure. For example, some of the operations depicted may be performed in parallel or in a different sequence that does not materially affect the function of the method 300. In some examples, different components of an example device or system that implements the method 300 may perform functions at substantially the same time or in a specific sequence.

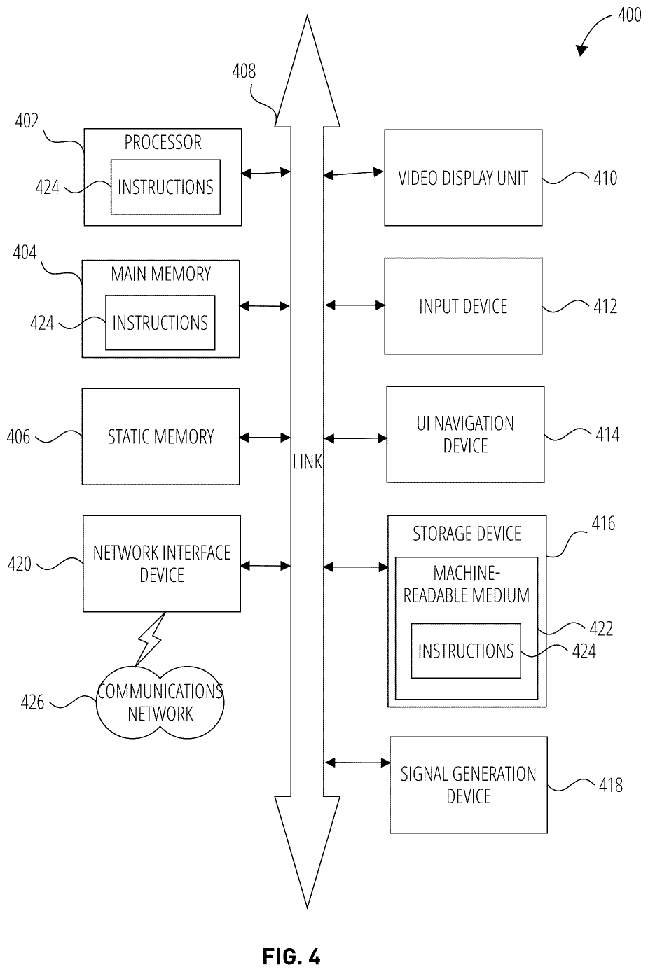

A processing unit, which executing the set of instructions, may configure the processing unit to perform the operations illustrated in FIG. 4. The processing unit may instruct other component of a computing device to carry out the set of instructions. For example, the processing unit may instruct a network device to transmit data to another computing device or the computing device may provide data over a display interface to present a user interface. In some examples, performance of the method may be split across multiple computing devices using a shared computing infrastructure (e.g., the processing unit encompasses multiple distributed computing devices).

In various examples, at block 302, method 300 receives a request to perform an action with a mobile application, the request including a user identifier and a set of authentication parameters. The mobile application 126 may receive this request, which may be initiated by a user attempting to perform an action within the application. In various examples, the set of authentication parameters may include a numerical code but exclude a password. The set of authentication parameters may depend on the action. In various examples, the action may be a first action and the risk level may be a first risk level. The method 300 may receive a request to perform a second action with the mobile application. The second action may follow a similar process as the first action as described above.

In various examples, the user identifier included in the request serves as a unique identifier for the user within the system. This identifier may be associated with a user profile stored in the user accounts 118, which contains information such as the user's credentials, preferences, and authentication history. Upon receiving the request, the system may initiate the process of evaluating the provided authentication parameters to determine if they are sufficient for the requested action.

In various examples, at block 304, method 300 determines that the set of authentication parameters are insufficient to authenticate the user identifier for the action. This determination may be performed by the authentication component 120, which evaluates the provided authentication parameters. The determination process may involve checking the provided authentication parameters against stored information in the user accounts 118. For instance, if the set of authentication parameters includes a numerical code (such as a PIN), the system may verify this against the stored PIN hash associated with the user identifier.

The authentication component 120 may work in conjunction with the risk level component 122 to implement a risk-based authentication system. The risk level component 122 may classify the requested action to a specific risk level based on factors such as the nature of the action, the sensitivity of the data involved, or the potential impact on the user's account. In various examples, the authentication component 120 may compare the specific risk level to a current authentication level of the user. In various examples, if the current authentication level is insufficient for a risk level of the requested action, the system may determine that additional authentication may be required. In other examples, if the current authentication level is sufficient for a risk level of the requested action, the system may approve the action.

In various examples, the authentication component 120 may maintain records of current authentication levels for user sessions, allowing for tracking of the authentication status of users throughout their interactions with the application. These records may include information such as the types of authentication methods used, the timestamp of the last successful authentication, and the current authentication level assigned to the session.

In various examples, the action may be a first action and the risk level may be a first risk level. The method 300 may receive a request to perform a second action with the mobile application. The method 300 may classify the second action to a second risk level. In various examples, the second risk level may be higher than the first risk level. The authentication component 120 may compare the second risk level to a current level of authentication of the user identifier. In various examples, the current level of authentication of the user identifier may be insufficient for the second risk level. An additional authentication parameter may be requested. The additional authentication parameter may be a password or a non-password authentication parameter, such as a PIN or recovery question.

In various examples, at block 306, method 300 requests an additional authentication parameter. This request may be transmitted to the digital wallet 124 installed on the client device 104. The additional authentication parameter requested at this stage may be an encoded identification identifier derived from a mobile driver's license stored within the digital wallet application. In various examples, this transmission may occur through a deep link encoded with an identifier of the mobile application and user identifier. The deep link may allow for integration between the mobile application 126 and the digital wallet 124, and may facilitate a smooth user experience during the additional authentication process.

In various examples, at block 308, method 300 receives an encoded identification identifier from a digital wallet application. The digital wallet application may provide this encoded identification identifier, which may come from a mobile driver's license stored within the digital wallet application. In some examples, this encoded identification identifier may be digitally signed to ensure its authenticity and integrity. The encoded identification identifier may be derived from a mobile driver's license stored within the digital wallet application. The process of receiving the encoded identification identifier may involve communication between the digital wallet 124 and the mobile application 126, facilitated by the deep link that was potentially used in the previous step. In various examples, the encoded identification identifier may be digitally signed to ensure its authenticity and integrity.

In various examples, at block 310, method 300 verifies the encoded identification identifier from the digital wallet application matches an encoded identification identifier associated with the user identifier. This verification process may be performed by the authentication component 120. The authentication component 120 may compare the received identifier against information stored in the system. The process of receiving the encoded identification identifier may involve communication between the digital wallet 124 and the mobile application 126, facilitated by the deep link that was potentially used in the previous step. The authentication component 120 may access the user accounts 118 to retrieve the encoded identification identifier associated with the user identifier. This stored identifier may have been previously registered during the user's account setup or a prior authentication process. In various examples, the verification process may involve decryption or decoding the received identifier before comparing it to the stored version.

In various examples, this verification process may involve communicating with the authority that issued the mobile driver's license to confirm the authenticity of the identifier.

This communication may be initiated by the authentication component 120 as an additional security measure. The issuing authority, which may be accessed through the digital identity server 128, may verify the authenticity of the identifier by checking a digital signature and comparing it against a record. The communication with the issuing authority may occur through secure channels, potentially using encrypted protocols to protect the sensitive nature of the identification data being transmitted. The authentication component 120 may wait for a response from the issuing authority before proceeding with the authentication process. In various examples, if the encoded identification identifier is digitally signed, the authentication component 120 may verify the digital signature. This verification may involve using a corresponding public key to check the signature's validity.

If the verification is successful, the system may proceed to the next step of authorizing the requested action. If the verification fails, the system may deny the action or request additional authentication, depending on its configuration and the risk level associated with the requested action.

In various examples, at block 312, method 300 authorizes the requested action to be performed on the mobile application. The authentication component 120 may grant the authorization. Once the encoded identification identifier from the digital wallet application has been verified to match the one associated with the user identifier, the system may determine that the user has provided sufficient authentication to proceed with the requested action. If the verification is successful, the system may authorize the requested action to be performed on the mobile application 126. Once authorized, the mobile application 126 may proceed to execute the requested action. This may involve various operations depending on the nature of the application and the specific action requested, such as accessing sensitive information, performing a financial transaction, modifying account settings, or the like. In various examples, the authorization may have a limited duration or scope. For instance, the system may authorize the specific requested action but may require re-authentication for subsequent high-risk actions or after a certain period of time has elapsed.

In various examples, the authorization process may involve updating the user's current authentication level within the system. The authentication component 120 may maintain records of current authentication levels for user sessions, and method 300 may elevate the user's authentication status to reflect the successful additional authentication. In various examples, the authentication component 120 may log the successful authorization as part of its comprehensive audit logs.

The method 300 may incorporate adaptive authentication based on the risk level of the requested action. For instance, if a user requests a second action with a higher risk level than the first, the system may compare this new risk level to the current level of authentication. If the current authentication level is insufficient for the higher-risk action, the system may request another additional authentication parameter. This additional parameter may be a password, demonstrating how the system may escalate the authentication requirements based on the risk level of the requested actions.

FIG. 4 is a block diagram illustrating a machine in the example form of computer system 400, within which a set or sequence of instructions may be executed to cause the machine to perform any of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) Network environments. The machine may be an onboard vehicle system, wearable device, personal computer (PC), tablet PC, hybrid tablet, personal digital assistant (PDA), mobile telephone, or any machine capable of executing instructions (sequential or otherwise) that specify actions to be taken by that machine. Further, while only a single machine is illustrated, the term “machine” includes any collection of machines that individually or jointly execute a set (or multiple sets) of instructions to perform any of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein Example computer system 400 includes at least one processor 402 (e.g., a central processing unit (CPU), a graphics processing unit (GPU) or both, processor cores, compute nodes, etc.), a main memory 404, and a static memory 406, which communicate with each other via a link 408. The computer system 400 may include a video display unit 410, an input device 412 (e.g., a keyboard), and a user interface UI navigation device 414 (e.g., a mouse). In an example, the video display unit 410, input device 412, and UI navigation device 414 are incorporated into a single device housing, such as a touchscreen display. The computer system 400 may additionally include a storage device 416 (e.g., a drive unit), a signal generation device 418 (e.g., a speaker), a network interface device 420, and one or more sensors (not shown), such as a global positioning system (GPS) sensor, compass, accelerometer, or other sensors.

The storage device 416 includes a machine-readable medium 422 on which one or more sets of data structures and instructions 424 (e.g., software) embodying or utilized by any of the methodologies or functions described herein. The instructions 424 may also reside, completely or at least partially, within the main memory 404, the static memory 406, or within the processor 402 during execution thereof by the computer system 400, with the main memory 404, the static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database or associated caches and servers) that store the instructions 424. The term “machine-readable medium” shall also be taken to include any tangible medium that is capable of storing, encoding, or carrying instructions for execution by the machine and that causes the machine to perform any one or more of the methodologies of the present disclosure or that is capable of storing, encoding or carrying data structures utilized by or associated with such instructions. The term “machine-readable medium” includes, but is not limited to, solid-state memories and optical and magnetic media. Specific examples of machine-readable media include non-volatile memory, including but not limited to, by way of example, semiconductor memory devices (e.g., electrically programmable read only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 422 that excludes transitory signals.

The instructions 424 may be transmitted or received over a communications network 426 using a transmission medium via the network interface device 420 utilizing a transfer protocol (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine and includes digital or analog communications signals or other intangible mediums to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

1. A method comprising:
receiving a request to perform an action with a mobile application, the request including a user identifier and a set of authentication parameters;
evaluating the user identifier and the set of authentication parameters against an authentication requirement for the action;
based on the evaluation, determining that the set of authentication parameters are insufficient to authenticate the user identifier for the action;
based on the determining, requesting an additional authentication parameter;
subsequent to the requesting, receiving an encoded identification identifier from a digital wallet application;
verifying the encoded identification identifier from the digital wallet application matches an encoded identification identifier associated with the user identifier; and
based on the verifying, authorizing the requested action to be performed on the mobile application.

2. The method of claim 1, wherein the set of authentication parameters includes a numerical code and excludes a password.

3. The method of claim 1, wherein requesting an additional authentication parameter includes transmitting a request to the digital wallet application for the additional authentication parameter.

4. The method of claim 3, wherein transmitting a request to the digital wallet application for the additional authentication parameter includes executing a deep link encoded with an identifier of the mobile application and user identifier.

5. The method of claim 1 further comprising:
classifying the action to a risk level.

6. The method of claim 5, wherein determining that the set of authentication parameters are insufficient to authenticate the user identifier for the requested action includes:
comparing the risk level to a current level of authentication of the user identifier.

7. The method of claim 5, wherein the action is a first action and the risk level is a first risk level.

8. The method of claim 7, wherein the method further comprises:
receiving a request to perform a second action with the mobile application;
classifying the second action to a second risk level, the second risk level being higher than the first risk level;
comparing the second risk level to a current level of authentication of the user identifier; and
based on determining the current level of authentication of the user identifier is insufficient for the second risk level, requesting another additional authentication parameter.

9. The method of claim 8, wherein the another additional authentication parameter is a password.

10. The method of claim 1, wherein the encoded identification identifier is from a mobile driver's license stored in the digital wallet application, the encoded identification identifier digitally signed.

11. The method of claim 10, wherein verifying the encoded identification identifier from the digital wallet application matches the encoded identification identifier associated with the user includes transmitting a request to an authority that issued the mobile driver's license.

12. A system comprising:
a processing unit; and
a storage device comprising instructions, which when executed by the processing unit, configure the processing unit to perform operations comprising:
receive a request to perform an action with a mobile application, the request including a user identifier and a set of authentication parameters;
evaluate the user identifier and the set of authentication parameters against an authentication requirement for the action;
based on the evaluation, determine that the set of authentication parameters are insufficient to authenticate the user identifier for the action, based on the determination, request an additional authentication parameter;
subsequent to the request, receive an encoded identification identifier from a digital wallet application;
verify the encoded identification identifier from the digital wallet application matches an encoded identification identifier associated with the user identifier; and
based on the verification, authorize the requested action to be performed on the mobile application.

13. The system of claim 12, wherein the set of authentication parameters includes a numerical code and excludes a password.

14. The system of claim 12, wherein the instructions to request an additional authentication parameter include instructions to transmit a request to the digital wallet application for the additional authentication parameter.

15. The system of claim 12, wherein the instructions further configure the processing unit to classify the action to a risk level.

16. The system of claim 12, wherein the encoded identification identifier is from a mobile driver's license stored in the digital wallet application, the encoded identification identifier digitally signed.

17. A non-transitory computer-readable medium comprising instructions, which when executed by a processing unit, configure the processing unit to perform operations comprising:
receive a request to perform an action with a mobile application, the request including a user identifier and a set of authentication parameters;
evaluate the user identifier and the set of authentication parameters against an authentication requirement for the action;
based on the evaluation, determine that the set of authentication parameters are insufficient to authenticate the user identifier for the action,
based on the determination, request an additional authentication parameter;
subsequent to the request, receive an encoded identification identifier from a digital wallet application;
verify the encoded identification identifier from the digital wallet application matches an encoded identification identifier associated with the user identifier; and
based on the verification, authorize the requested action to be performed on the mobile application.

18. The non-transitory computer-readable medium of claim 17, wherein the set of authentication parameters includes a numerical code and excludes a password.

19. The non-transitory computer-readable medium of claim 17, wherein the instructions to request an additional authentication parameter include instructions to transmit a request to the digital wallet application for the additional authentication parameter.

20. The non-transitory computer-readable medium of claim 17, wherein the encoded identification identifier is from a mobile driver's license stored in the digital wallet application, the encoded identification identifier digitally signed.
